(19) United States
(12) Patent Application Publication
(10) Pub. No.: US 2009/0040553 A1
(43) Pub. Date: Feb. 12, 2009

(54) INFORMATION PROCESSING APPARATUS, IMAGE FORMING APPARATUS, AND METHOD FOR CONTROLLING INFORMATION PROCESSING APPARATUS

(76) Inventors: Takahiro Minami, Yamatokoriyama-shi (JP); Masaki Inui, Yamatokoriyama-shi (JP)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 12/187,519

(22) Filed: Aug. 7, 2008

(30) Foreign Application Priority Data
Aug. 8, 2007 (JP) 2007-207069

(51) Int. Cl. G06F 3/12

(52) U.S. Cl. 358/1.15; 358/443

(57) ABSTRACT

There are provided an information processing apparatus capable of reducing power consumption more than ever without deteriorating processing efficiency in the apparatus as a whole, an image forming apparatus, and a method for controlling the information processing apparatus. When the operation mode is in a sleep mode or an energy save mode at the time of receiving a facsimile data by a FAX modem, an instruction is made not to an image processing chip but to an IO chip to perform image processing for the received facsimile data. The IO chip performs the image professing using an LCDC (Liquid Crystal Display Controller). During this time, main control sections such as an SoC is remained in the non-energized state.

### CROSS-REFERENCE TO RELATED APPLICATION

This application claims priority to Japanese Patent Application No. 2007-207069, which was filed on Aug. 8, 2007, the contents of which are incorporated herein by reference in its entirety.

### BACKGROUND OF THE INVENTION

1. Field of the Invention

The present invention relates to an information processing apparatus, an image forming apparatus, and a method for controlling the information processing apparatus.

2. Description of the Related Art

With the trend toward improving functions of a multi-function peripheral in which functions of a copier, a printer and the like are combined, the multi-function peripheral consumes larger amount of power, and therefore a so-called energy save mode that the power is supplied to only minimum configuration depending on usage state and power supply for most parts is stopped has been introduced.

Further, a multi-function peripheral is provided with an interface for connecting to a network to perform data communication. Such an interface is often provided on a sub-substrate called NIC (Network Interface Card), and many elements such as a CPU (Central Processing Unit) for controlling a whole of an apparatus are provided on a main-substrate.

A multi-function peripheral which operates in the energy save mode is configured so that, for example, power supply to a CPU for control is stopped and power is supplied only to an NIC for performing data communication and a fax modem for performing facsimile communication.

In a multi-function peripheral and the like, a CPU performs control for a whole of an apparatus, and an ASIC (Application Specific Integrated Circuit) or an IC (Integrated Circuit) exclusive for each processing is used for image processing and display control processing in which load of arithmetic processing becomes large.

Since such an ASIC and an IC have a high calculation capability, when the arithmetic load by the ASIC and the IC is small, performance of the ASIC and the IC sometimes can not be fully utilized.

An image processing apparatus described in Japanese Unexamined Patent Publication JP-A 2006-135878 performs power supply to an operation/display section and a main control section based on a trigger signal which is outputted when the operation/display section is operated during an energy save mode, in order to prevent wasteful power consumption.

The image processing apparatus described in the JP-A 2006-135878 is configured so that a mode of the apparatus is shifted to the energy save mode by an operation instruction from a user, wherein the user energizes a CPU serving as a main control section and the operation/display section to give an instruction to recover the apparatus.

However, although the CPU is energized, the CPU only detects the state of the operation display section, thus the power is supplied to the CPU wastefully.

### SUMMARY OF THE INVENTION

An object of the invention is to provide an information processing apparatus capable of reducing power consumption more than ever without deteriorating processing efficiency in the apparatus as a whole, an image forming apparatus, and a method for controlling the information processing apparatus.

The invention provides an information processing apparatus, comprising: a main control section for controlling a part or whole of the apparatus; and at least one sub control section for controlling a specific function, in the case where the main control section is in the non-energized state, the sub control section controlling another specific function different from the specific function to be controlled.

According to the invention, an information processing apparatus, comprises a main control section for controlling a part or whole of the apparatus; and at least one sub control section for controlling a specific function, and in the case where the main control section is in the non-energized state, the sub control section controls another specific function different from the specific function to be controlled.

Even when the main control section is in the non-energized state under an energy save mode and the like, by causing the sub control section to control another specific function, a specific function is executable at nighttime, resulting that it is possible to further reduce power consumption without deteriorating processing efficiency of the whole of the apparatus.

Furthermore, in the invention, it is preferable that the control of the another specific function is carried out when the information processing apparatus is stopped.

According to the invention, the control of the another specific function is carried out when the information processing apparatus is stopped.

As a result, it is possible to further reduce power consumption.

Furthermore, in the invention, it is preferable that the main control section and the sub control section are connected to each other so as to transmit and receive data through a PCI bus or a PCI-Express bus.

According to the invention, the main control section and the sub control section are connected to each other so as to transmit and receive data through a PCI bus or a PCI-Express bus.

As a result, since the main control section in the non-energized state is made in a float state, it is possible to control another specific function by the sub control section without affecting other parts.

Furthermore, in the invention, it is preferable that the sub control section and a device that carries out the specific function are connected to each other so as to transmit and receive data through a PCI bus, a PCI-Express bus or a dedicated data bus.

According to the invention, the sub control section and a device that carries out the specific function are connected to each other so as to transmit and receive data through a PCI bus, a PCI-Express bus or a dedicated data bus.

The device that carries out the specific function is often provided with the PCI-bus and the PCI-Express as a general-purpose interface. By using these data buses as the information processing apparatus, it is possible to unify connection with other circuits and control in the information processing apparatus, thus making it possible to simplify and unify the structure of circuits.

Furthermore, in the invention, it is preferable that the sub control section is any one of an image processing section and a liquid crystal display controller.

According to the invention, the sub control section is any one of an image processing section and a liquid crystal display controller.

The image processing section serves preferably as the sub control section since the image processing section uses an exclusive ASIC and has a high calculation capability. Furthermore, the liquid crystal display controller is preferably capable of performing image processing instead of the image processing section.

Furthermore, in the invention, it is preferable that the sub control section performs image processing or history management as the another specific function.

According to the invention, the sub control section performs image processing or history management as the another specific function.

As a result, by performing image processing or history management when the processing is not to be performed in a hurry under the energy save mode and the like, it is possible to improve processing efficiency in the whole apparatus.

Furthermore, the invention provides an image forming apparatus comprising the information processing apparatus.

According to the invention, by comprising the information processing apparatus, it is possible to further reduce power consumption without deteriorating processing efficiency of the whole of the image forming apparatus.

Furthermore, the invention provides a control method of the information processing apparatus, in the case where a main control section that controls a part or whole of an apparatus is in the non-energized state, at least one sub control section that controls a specific function controlling another specific function different from the specific function to be controlled.

According to the invention, in the case where a main control section that controls a part or whole of an apparatus is in the non-energized state, at least one sub control section that controls a specific function controlling another specific function different from the specific function to be controlled.

Even when the main control section is in the non-energized state under an energy save mode and the like, by causing the sub control section to control another specific function, a specific function is executable at nighttime, resulting that it is possible to further reduce power consumption without deteriorating processing efficiency of the whole of the apparatus.

### BRIEF DESCRIPTION OF THE DRAWINGS

Other and further objects, features, and advantages of the invention will be more explicit from the following detailed description taken with reference to the drawings wherein:

FIG. 1 is a sectional view showing the structure of a digital multi-function peripheral according to an embodiment of the invention;

FIG. 2 is a block diagram showing the electric configuration of the digital multi-function peripheral;

FIG. 3 is a view showing the electric configuration of the inside of an To chip;

FIG. 4 is a flowchart showing control processing when facsimile data is received in a sleep mode; and

FIG. 5 is a flowchart showing processing of generating a job history by the IO chip.

### DETAILED DESCRIPTION

Now referring to the drawings, preferred embodiments of the invention are described below.

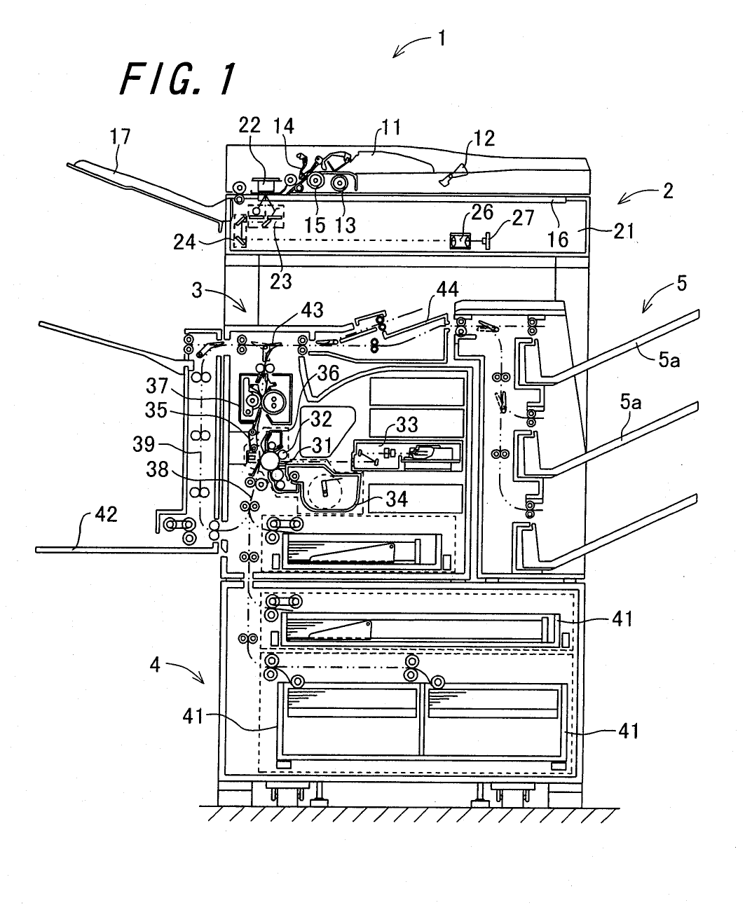

FIG. 1 is a sectional view showing the structure of a digital multi-function peripheral 1 according to an embodiment of the invention. The digital multi-function peripheral 1 is capable of selectively performing a copy mode in which images in a document are read and printed on recording sheets, a facsimile mode in which images in a document are read and transmitted, or images in a document are received and printed on recording sheets, and a printer mode in which images received through a network from an information terminal apparatus are printed on recording sheets. The digital multi-function peripheral 1 generally has a configuration including a document transporting and reading section 2, an image forming section 3, a paper feed section 4, a paper ejection processing apparatus 5.

Next, the operation of the digital multi-function peripheral 1 will be described by taking the copy mode as an example.

First, when a document is set on a document set tray 11 of the document transporting and reading section 2, a document detection sensor 12 detects that the document has been set. Then, by operating an operation panel 13 of the document transporting and reading section 2, a size of a print sheet, a magnification and the like are inputted and set. Thereafter, start of copying is instructed by the operation of the operation panel 13.

In response to these operations, in the document transporting and reading section 2, documents on the document set tray 11 are picked up one by one by a pickup roller 13, and the document passes between a separation plate 14 and a transport roller 15 to be fed to a platen glass 16, and then, the document is transported in a sub-scanning direction on the platen glass 16 to be ejected to a document ejection tray 17.

At this time, a front face (a lower face) of the document is read by a first reading section 21. After moving a first scanning unit 23 in the first reading section 21 to a position so as to be positioned and positioning a second scanning unit 24 at a predetermined position, the front face of the document is irradiated with light by an exposure lamp of the first scanning unit 23 through the platen glass 16, the reflected light from the document is guided to an imaging lens 26 by each reflection mirror in the first and the second scanning units 23 and 24, the reflected light from the document is collected to a CCD (Charge Coupled Device) image sensor 27 by the imaging lens 26, an image on the front face of the document is formed on the CCD image sensor 27, and thereby the image on the front face of the document is read.

In addition, a rear face (an upper face) of the document is read by a second reading section 22. The second reading section 22 is disposed above the platen glass 16, and is provided with an exposure lamp (an LED (Light Emitting Diode) array, a fluorescent lamp, and the like) for illuminating a rear face of a document, a Selfoc lens array for collecting reflected light from a document for each pixel, a contact image sensor (CIS) for performing photoelectric conversion of reflected light from a document that is received through the Selfoc lens array and outputting an analogue image signal, and the like.

Further, an upper housing of the document transporting and reading section 2 is opened and a document is placed on the platen glass 16, and under the state of which the front face of the document is capable of being read by the first reading section 21. In this case, the first and the second scanning units 23 and 24 are moved in the sub-scanning direction while a predetermined speed relationship is maintained, the document on the platen glass 16 is exposed to light by the first scanning unit 23, the reflected light from the document is guided to the imaging lens 26 by the first and the second scanning units 23 and 24, and an image of the document is formed on the CCD image sensor 27 by the imaging lens 26.

After one side or both sides of the document are read in such a manner, image data indicating the image on the one side or both sides of the document is inputted into a control section such as a microcomputer, and image data is subjected to various kinds of image processing and then outputted to the image forming section 3.

The image forming section 3 prints the image of the document indicated by the image data on a recording sheet, and is provided with a photoreceptor drum 31, a charging device 32, a laser scanning unit (hereinafter referred to as an LSU) 33, a developing device 34, a transfer device 35, a cleaning device 36, a charge removal device (not shown), a fixing device 37, and the like.

Moreover, the image forming section 3 is provided with a main transport path 38 and a reverse transport path 39, wherein a recording sheet fed from the paper feed section 4 is transported along the main transport path 38. The paper feed section 4 picks up recording sheets stored in a paper feed cassette 41 or recording sheets placed on a manual paper feed tray 42 one by one to convey to the main transport path 38 in the image forming section 3.

While a recording sheet is being transported along the main transport path 38 in the image forming section 3, the recording sheet passes between the photoreceptor drum 31 and the transfer device 35, further passes through the fixing device 37, and printing is performed for the recording sheet. The photoreceptor drum 31 rotates in one direction, and after the surface thereof is cleaned by the cleaning device 36 and the charge removal device, the surface is charged uniformly by the charging apparatus 32. The laser scanning unit 33 modulates laser light in accordance with image data from the document transporting and reading section 2, and the surface of the photoreceptor drum 31 is repeatedly scanned with the laser light in a main scanning direction so that an electrostatic latent image is formed on the surface of the photoreceptor drum 31. The developing device 34 supplies a toner onto the surface of the photoreceptor drum 31, develops the electrostatic latent image, and forms a toner image on the surface of the photoreceptor drum 31. The transfer device 35 transfers the toner image on the surface of the photoreceptor drum 31 to the recording sheet passing between the transfer device 35 and the photoreceptor drum 31. The fixing device 37 fixes the toner image on the recording sheet by heating and pressing the recording sheet.

A branch claw 43 is disposed at a connecting position of the main transport path 38 and the reverse transport path 39. When printing is performed only on one side of the recording sheet, the branch claw 43 is positioned and the recording sheet from the fixing device 37 is guided toward a paper ejection tray 44 or the paper ejection processing apparatus 5 by the branch claw 43.

In addition, when printing is performed on both sides of the recording sheet, the branch claw 43 is pivotally displaced in a position indicated by dotted line, and the recording sheet is guided to the reverse transport path 39. Then, the recording sheet passes through the reverse transport path 39, and is, reversed to be transported again to the main transport path 38, and printing is performed on the rear face while the recording sheet is being transported again to the main transport path 38, followed by being guided to the paper ejection tray 44 or the paper ejection processing apparatus 5.

The recording sheet thus printed is guided to the paper ejection tray 44 or the paper ejection processing apparatus 5, and is ejected to the paper ejection tray 44 or ejected to one of paper ejection trays 5a in the paper ejection processing apparatus 5.

In the paper ejection processing apparatus 5, a plurality of recording sheets are sorted and ejected to each of the paper ejection trays 5a, punching processing is applied to each recording sheet, or staple processing is applied to each recording sheet. For example, when a plurality of sets of printed materials are created, recording sheets are sorted and ejected to each of the paper ejection trays 5a so that a set of printed materials is allocated to each of the paper ejection trays 5a, and punching-processing and staple processing are applied to each set of the recording sheets on the paper ejection trays 5a for each paper ejection tray 5a, followed by creating the printed materials.

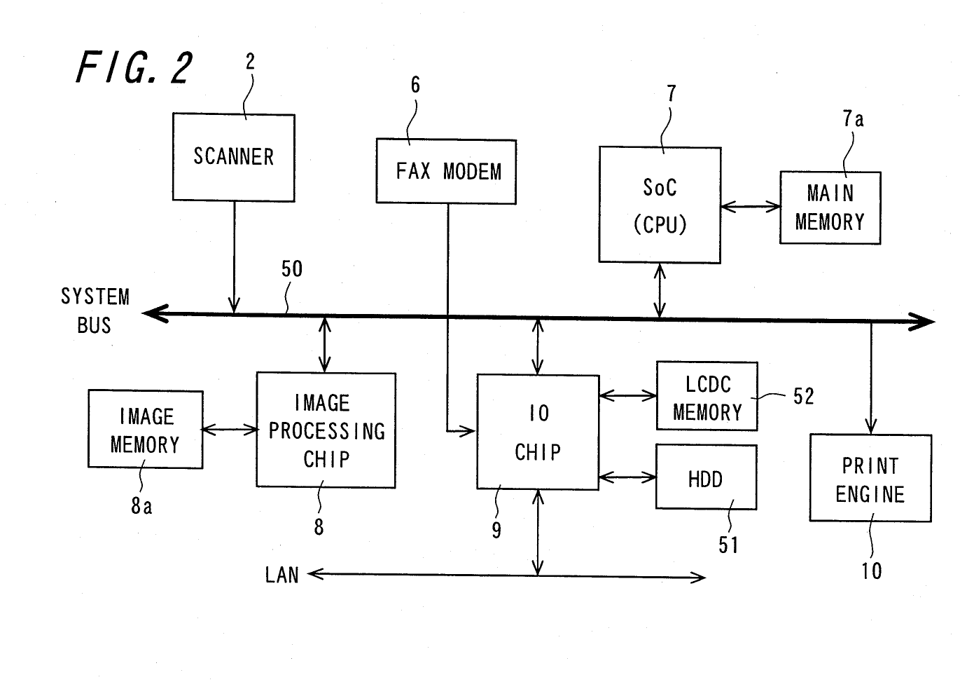

FIG. 2 is a block diagram showing the electric configuration of the digital multi-function peripheral 1.

A scanner apparatus 2 corresponds to the document transporting and reading section 2, and performs reading of a document image and performs image processing such as shading and correction of light quantity. A FAX modem 6 receives and transmits facsimile data by facsimile communication, and is provided with a different power source from that of the multi-function peripheral, by which facsimile data can be received even when the multi-function peripheral 1 is in the non-energized state.

An SoC (System on Chip) 7 which includes a CPU such as a microcomputer is a main control section for performing control of a whole of the multi-function peripheral. The SoC 7 is provided with a main memory 7a which is a temporal storage section necessary for arithmetic processing and development of a program.

An image processing chip 8 applies image processing to image data which is received from the scanner 2, an external PC (personal computer) or the like, and includes therein an A/D conversion section, a shading correction section, an input tone correction section, a segmentation process section, a color correction section, a black generation and under color removal section, a spatial filter process section, an output tone correction section, and a tone reproduction process section, wherein an ASIC exclusive for image processing is used. The image processing chip 8 is provided with an image memory 8a for storing image data for one screen, which is necessary for performing image processing.

An IO chip 9 which performs an interface with other devices in the multi-function peripheral, includes, for example, a GPU (Graphics Processing Unit) such as an LCDC (Liquid Crystal Display Controller) for performing control of a liquid crystal display apparatus, and incorporates a CPU for performing arithmetic processing necessary for display of 3D (three-dimensional) graphics. The IO chip 9 is connected to an HDD (Hard Disk Drive) which is a large-capacity storage device for storing image data, facsimile data, and the like, and an LCDC memory 52 for storing display data for one screen of the liquid crystal display apparatus.

A print engine 10 receives image data after image processing by the image processing chip 8 and carries out print processing.

A system bus 50 includes a system bus complying with a general-purpose bus standard such as a PCI and a PCT-Express, and is used for transmitting and receiving data, such as control data and image data, in the multi-function peripheral.

Thus, since the main control section in the non-energized state is in a float state, it is possible to control other specific functions by a sub control section without affecting other parts. In addition, a device such as the IO chip 9 for executing a specific function is often provided with a PCI bus and a PCI-Express as a general-purpose interface. By using these data buses as an information processing apparatus, it is possible to unify connection with other circuits and control in the information processing apparatus, thus making it possible to simplify and unify the structure of circuits.

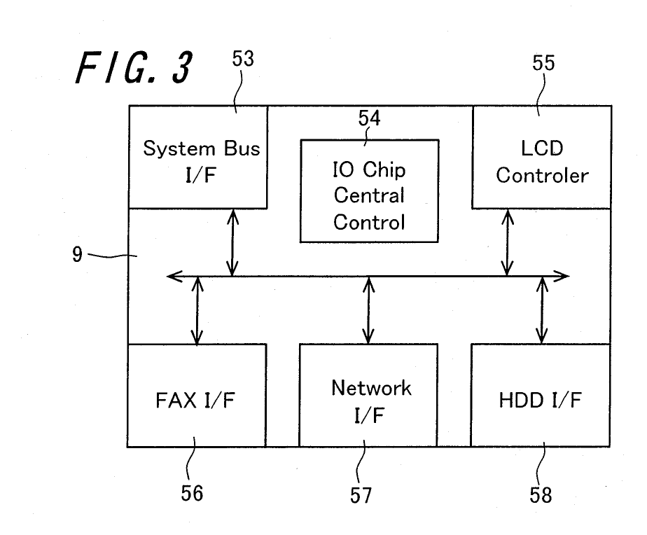

FIG. 3 is a view showing the electric configuration of the inside of the IO chip 9.

A system bus I/F is an interface with a system bus for exchanging image data or control data with each chip. An IO chip central control 54 is a block for controlling the operation of the whole of the IO chip 9. The TO chip central control 54 has a local bus I/F and the like, and controls the IO chip 9 as a whole in accordance with an instruction from the SoC.

The LCDC 55 performs control for the liquid crystal display apparatus. A FAX interface performs control for the FAX modem 6, and transmits and receives facsimile data. A network interface 57 is an interface for performing data communication with an external device of the multi-function peripheral such as a PC through a LAN cable by a prescribed protocol, and an HDD interface 58 is an interface for writing and reading data to and from the HDD 51.

When the multi-function peripheral 1 is energized, the multi-function peripheral 1 initializes electric input/output ports, a memory, and a process, and thereafter reads out prescribed data from a nonvolatile memory, and thereby the multi-function peripheral 1 is set to an initial state which is stored as an initial value of the apparatus and is set at the time of copy and facsimile processing. In addition, the process is initialized, and a temperature in the fixing device and the number of rotation of a polygon mirror in a laser operation unit reach predetermined values, and thereby the multi-function peripheral 1 becomes a state of waiting for an instruction from a user as a copy ready state (ready).

However, after turning on the power source or after the copy, when the multi-function peripheral 1 is left for a long time without any operation, temperature control is carried out to maintain a constant temperature at all times in the fixing device, thus the power is consumed wastefully.

Hence, the multi-function peripheral 1 includes a standby mode (an energy save mode) and a sleep mode, in addition to a normal standby mode.

In the energy save mode, when the multi-function peripheral 1 is not used for a long time and is left as it is, in order to reduce power consumption in the multi-function peripheral 1, a set temperature in the fixing device, a rotation speed of a polygon mirror, or a light quantity of a light source for reading is decreased so that the power consumption is reduced.

Moreover, when an instruction of copying or an instruction of printing is inputted, it is possible that the fixing temperature and the polygon mirror are recovered to the print ready state, thus making it possible to reduce wasteful power consumption without giving a user unpleasant waiting time.

The sleep mode is adapted when the multi-function peripheral 1 is not used for a prescribed time such as at nighttime, wherein the electric current is carried so that a minimum-required data communication function, such as the FAX modem 6, and the IO chip 9 including the network interface 57 is operated, and the current to other parts such as the SoC 7, which is not necessary for data communication, is cut off, so as to reduce the power.

Accordingly, facsimile data transmitted at nighttime, or the like is stored in a nonvolatile memory in a communication circuit and is printed when the multi-function peripheral 1 is restarted, thus reducing wasteful power consumption.

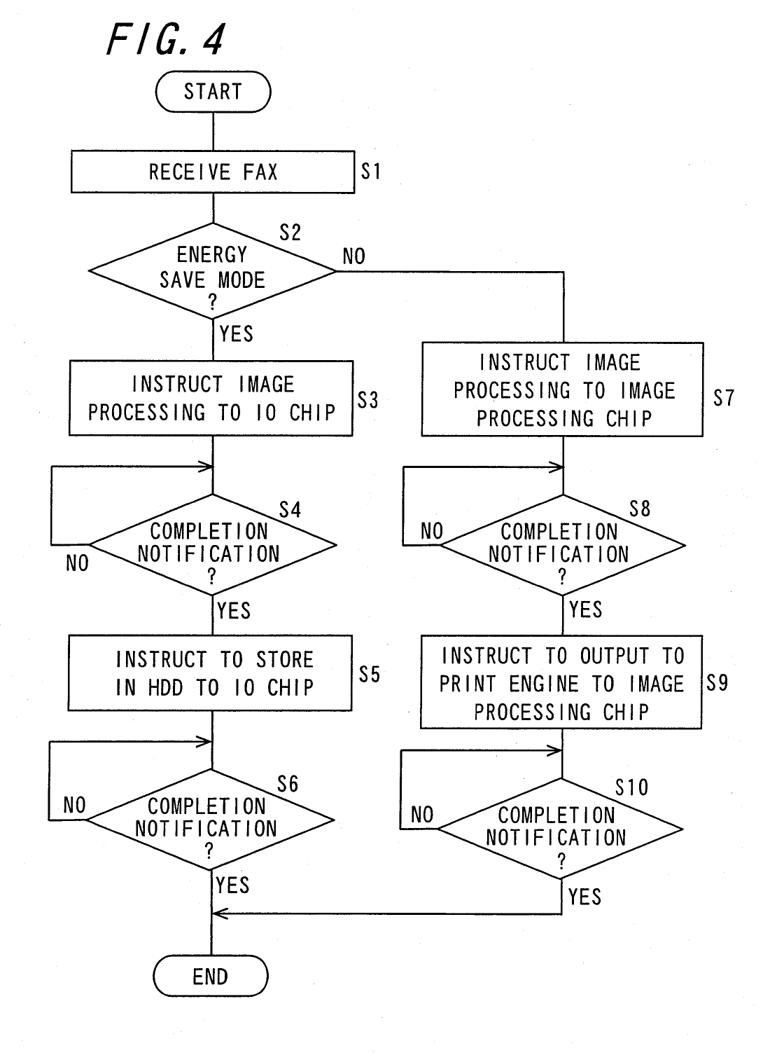

FIG. 4 is a flowchart showing control processing when facsimile data is received in the sleep mode.

In a state where the multi-function peripheral 1 shifts to the sleep mode, main parts such as the SoC are in the non-energized state, and power is supplied only to the FAX modem 6 and the IO chip 9, facsimile data is received.

Although the SoC 7 as the main control section performs control when the SoC 7 is in the energized state, the image processing chip 8 or the LCDC 55 as the sub control section performs control when the SoC 7 is in the non-energized state.

In the processing of receiving facsimile data, since no printing is required immediately when there is no person around the apparatus such as at nighttime, there is no need of executing image processing after the data is received. Although the image processing chip 8 with a high processing speed performs the image processing, the LCDC 55 performs the image processing when high processing speed is not required. At this time, the image processing chip 8 operates in the energy save mode by a clock stop and power supply stop.

First, when the FAX modem 6 receives facsimile data (step S1), whether or not the operation mode is in the sleep mode, and whether or not the whole of the multi-function peripheral 1 is in the energy save-mode are determined (step S2).

When the operation mode is in the sleep mode or the energy save mode, the IO chip 9 is instructed to perform image processing for the received facsimile data (step S3). Standby is performed until completion notification of the image processing is received from the IO chip 9 (step s4), and when the completion notification of the image processing is received, the IO chip 9 is instructed to perform an output to a print engine 10, and image data after the image processing is stored in the HDD 51 (step S5).

Standby is performed until completion notification of storage processing is received from the IO chip 9 (step s6), and when the completion notification is received, the processing is completed.

When the operation mode is not in the sleep mode or the energy save mode, the image processing chip 8 is instructed to perform image processing of the received facsimile data (step S7). Standby is performed until completion notification of the image processing is received from the image processing chip 8 (step S8), and when the completion notification of the image processing is received, the image processing chip 8 is instructed to perform an output to the print engine 10, and the print engine 10 is caused to print image data after the image processing (step S9).

Standby is performed until completion notification of print processing is received from the print engine 10 (step 310), and when the completion notification is received, the processing is completed.

As described above, in the case where high processing speed is not required when the operation mode is in the sleep mode, the energy save mode or the like, the IO chip 9 and the like having less power consumption is caused to perform image processing, resulting that it is possible to perform processing with low power consumption.

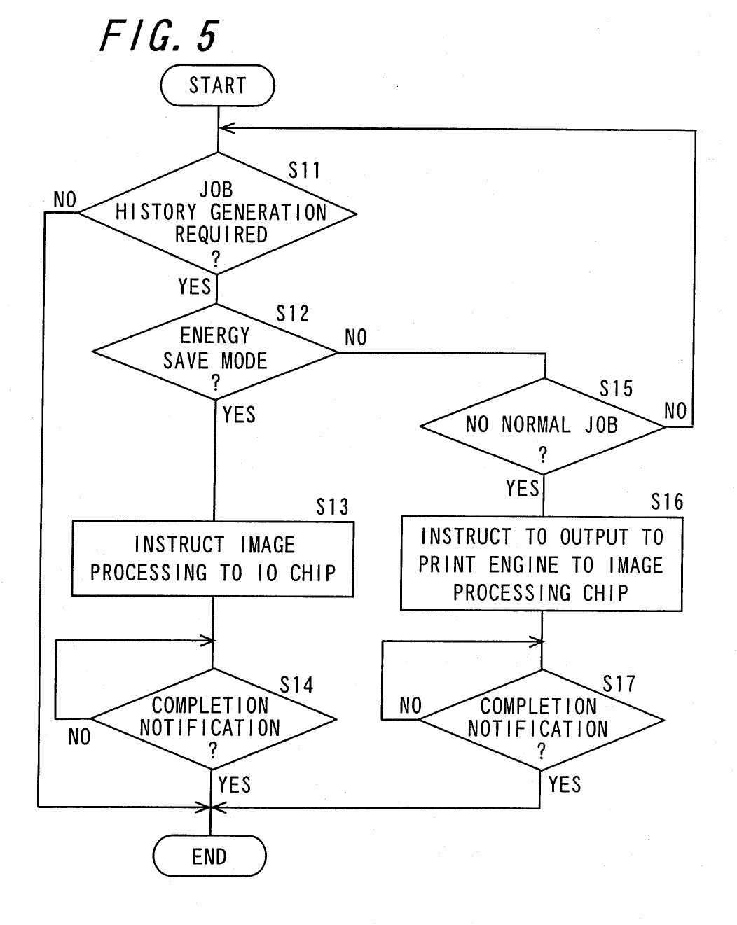

FIG. 5 is a flowchart showing processing of generating a job history by the IO chip 9.

Processing of generating a job history will be described by taking a case as an example, that image data is read out from the HDD 51, and thereafter image processing is performed and the image data is written into the HDD 51 again.

Although the SoC 7 as the main control section performs control when the SoC 7 is in the energized state, the image processing chip 8 or the LCDC 55 as the sub control section performs control when the SoC 7 is in the non-energized state.

Here, the job history is defined as one that scan image data and print image data stored in the HDD 51 are reduced in size and thumbnailed so that operation history in the multi-function peripheral 1 is left, and one that is obtained by totalizing stored job logs for each date and each user. There is no need of performing the history generating processing for each job, and it is preferable to perform during the energy save mode.

First, whether or not a history needs to be generated is determined (step S11). The determination of the necessity depends on whether or not there is job data that a history needs to be generated, that is, unprocessed data as a history.

When it is determined that a history needs to be generated, whether or not the multi-function peripheral 1 is in the energy save mode is determined (step S12). When it is determined that no generation is required, the processing is completed.

When the operation mode is in the energy save mode, the IO chip 9 is instructed to perform image processing (generation of thumbnails) and to total job logs (step S13). Standby is performed until completion notification of the history generating processing is received from the IO chip 9 (step S14), and when the completion notification is received, the processing is completed.

When the operation mode is not in the energy save mode, whether or not there is a normal job, whether or not other jobs are being operated, and whether or not it is required to perform the thumbnail generating processing in a hurry due to the capacity shortage of the HDD, are determined (step S15).

When there is a normal job, going back to step S11, and when there is no job, the image processing chip 8 is instructed to perform an output to the print engine 10, and to generate a thumbnail (step S16).

Standby is performed until completion notification of generation processing is received from the image processing chip 8 (step S17), and when the completion notification is received, the processing is completed.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An information processing apparatus, comprising:
a main control section for controlling a part or whole of the apparatus; and
at least one sub control section for controlling a specific function,
in the case where the main control section is in the non-energized state, the sub control section controlling another specific function different from the specific function to be controlled.

2. The image processing apparatus of claim 1, wherein the control of the another specific function is carried out when the information processing apparatus is stopped.

3. The image processing apparatus of claim 1, wherein the main control section and the sub control section are connected to each other so as to transmit and receive data through a PCI bus or a PCX-Express bus.

4. The image processing apparatus of claim 3, wherein the sub control section and a device that carries out the specific function are connected to each other so as to transmit and receive date through a PCI bus, a PCI-Express bus or a dedicated data bus.

5. The image processing apparatus of claim 1, wherein the sub control section is any one of an image processing section and a liquid crystal display controller.

6. The image processing apparatus of claim 5, wherein the sub control section performs image processing or history management as the another specific function.

7. An image forming apparatus comprising the information processing apparatus of claim 1.

8. A control method of the information processing apparatus, in the case where a main control section that controls a part or whole of an apparatus is in the non-energized state, at least one sub control section that controls a specific function controlling another specific function different from the specific function to be controlled.
